(19) United States
(12) Patent Application Publication
(10) Pub. No.: US 2024/0028379 A1
(43) Pub. Date: Jan. 25, 2024

(54) CACHE MANAGEMENT IN A HYPERCONVERGED INFRASTRUCTURE

(71) Applicants: Hossein Asadi, Tehran (IR); Mostafa Kishani Farahani, Tehran (IR); Saba Ahmadian Khameneh, Tehran (IR); Sina Ahmadi, Zanjan (IR)

(72) Inventors: Hossein Asadi, Tehran (IR); Mostafa Kishani Farahani, Tehran (IR); Saba Ahmadian Khameneh, Tehran (IR); Sina Ahmadi, Zanjan (IR)

(73) Assignees: High Performance Data Storage, Tehran (IR); Sharif University of Technology, Tehran (IR)

(21) Appl. No.: 18/358,618

(22) Filed: Jul. 25, 2023

Related U.S. Application Data
(60) Provisional application No. 63/391,804, filed on Jul. 25, 2022.

(51) Int. Cl. G06F 9/455; G06F 3/06

(52) U.S. Cl. CPC G06F 9/45558; G06F 3/0613; G06F 3/0683; G06F 3/0629; G06F 2009/45579; G06F 2009/45583

(57) ABSTRACT

A method for cache management in a hyperconverged infrastructure (HCI). The HCI includes a plurality of physical nodes (PNs). The method includes receiving a primary plurality of input/output (I/O) requests at a plurality of virtual machines (VMs), allocating a plurality of local caches (LCs) and a plurality of remote caches (RCs) to the plurality of VMs, receiving a secondary plurality of I/O requests at the plurality of VMs, and serving the secondary plurality of I/O requests. Each of the plurality of VMs runs on a respective corresponding PN of the plurality of PNs. The plurality of LCs and the plurality of RCs are allocated based on the primary plurality of I/O requests. The secondary plurality of I/O requests is served based on the plurality of LCs and the plurality of RCs.

### CROSS-REFERENCE TO RELATED APPLICATION

This application claims the benefit of priority from pending U.S. Provisional Patent Application Ser. No. 63/391,804, filed on Jul. 25, 2022, and entitled “ELICA: EFFICIENT AND LOAD BALANCED I/O CACHE ARCHITECTURE FOR HYPERCONVERGED INFRASTRUCTURES,” which is incorporated herein by reference in its entirety.

### TECHNICAL FIELD

The present disclosure generally relates to storage systems, and particularly, to caching in virtualized platforms.

### BACKGROUND

Hyperconverged Infrastructures (HCIs) replace legacy data center infrastructures by combining storage arrays, storage networks, and computing servers into an array of single physical nodes, managed under software-defined platforms. As a cost-efficient architecture, HCI finds applications in many different areas, including big data, virtual desktop infrastructure (VDI), video surveillance, and edge computing. HCIs are also promising when computational resource requirement of applications scales linearly with storage demand. Other benefits of HCIs are low provisioning cost and great scalability.

In HCI, multiple physical nodes may be connected to each other, while storage subsystem is distributed over different physical nodes, providing scalable capacity and performance. Each physical node may contain both storage and processing elements managed by a hypervisor hosting a storage virtual machine (SVM) to enable storage sharing across all physical nodes and multiple virtual machines (VMs). Both storage and performance capacities monotonically scale by adding extra nodes at no service downtime.

Despite various advantages, HCI platforms need to couple with a variety of performance improvement paradigms such as input/output (I/O) caching in virtualized platforms. I/O caching based on solid-state drives (SSDs) is widely used in enterprise systems. Conventional I/O caching schemes, however, are designed to work with legacy storage architectures and new techniques are necessary to adapt caching schemes into HCI platforms. VMs in existing enterprise HCIs are restricted to only use local cache space of host nodes, resulting in unfair resource allocation when one node faces a burst of I/O requests. One challenge of I/O caching in HCI may include imbalanced cache space requirement, that is, while some physical nodes host VMs with high cache space demands, other physical nodes may host less demanding VMs. Besides, some physical nodes may encounter a burst of I/O requests leading to a large cache performance drop, while other physical nodes may have idle cache bandwidth. An imbalanced cache management may negatively impact quality of service and average latency of VMs.

There is, therefore, a need for a cache management method that allocates cache space of both host node and remote nodes to each VM. There is also a need for a cache management scheme that balances cache space requirement and I/O requests across different physical nodes.

### SUMMARY

This summary is intended to provide an overview of the subject matter of the present disclosure, and is not intended to identify essential elements or key elements of the subject matter, nor is it intended to be used to determine the scope of the claimed implementations. The proper scope of the present disclosure may be ascertained from the claims set forth below in view of the detailed description below and the drawings.

In one general aspect, the present disclosure describes an exemplary method for cache management in a hyperconverged infrastructure (HCI). An exemplary HCI may include a plurality of physical nodes (PNs). An exemplary method may include receiving a primary plurality of input/output (I/O) requests at a plurality of virtual machines (VMs), allocating a plurality of local caches (LCs) and a plurality of remote caches (RCs) to the plurality of VMs, receiving a secondary plurality of I/O requests at the plurality of VMs, and serving the secondary plurality of I/O requests. In an exemplary embodiment, the primary plurality of I/O requests may be received utilizing one or more processors. In an exemplary embodiment, each of the plurality of VMs may run on a respective corresponding PN of the plurality of PNs. In an exemplary embodiment, the plurality of LCs and the plurality of RCs may be allocated utilizing the one or more processors. In an exemplary embodiment, the plurality of LCs and the plurality of RCs may be allocated based on the primary plurality of I/O requests. In an exemplary embodiment, the secondary plurality of I/O requests may be received and served utilizing the one or more processors. In an exemplary embodiment, the secondary plurality of I/O requests may be served based on the plurality of LCs and the plurality of RCs.

In an exemplary embodiment, allocating the plurality of LCs and the plurality of RCs may include allocating an (i, j)^{th} LC of the plurality of LCs and an (i, j)^{th} RC of the plurality of RCs to an (i, j)^{th} VM of the plurality of VMs where 1≤i≤N, 1≤j≤Nᵢ, N is a number of the plurality of PNs, Nᵢ is a number of the plurality of VMs running on an i^{th} PN of the plurality of PNs. An exemplary (i, j)^{th} VM may run on the i^{th} PN. An exemplary (i, j)^{th} LC may include a portion of a cache space of the i^{th} PN. An exemplary (i, j)^{th} RC may include a portion of a cache space of an l^{th} PN of the plurality of PNs where 1≤l≤N and l≠i.

In an exemplary embodiment, allocating the (i, j)^{th} LC and the (i, j)^{th} RC may include setting a first (1^{st}) plurality of RC sizes and a first (1^{st}) plurality of LC sizes to a plurality of initial values in a first (1st) time interval and obtaining a k^{th} plurality of RC sizes and a k^{th} plurality of LC sizes in a k^{th} time interval where k≥2. An exemplary first (1^{st}) plurality of RC sizes may include cache sizes of the plurality of RCs. An exemplary first (1^{st}) plurality of LC sizes may include cache sizes of the plurality of LCs. In an exemplary embodiment, obtaining the k^{th} plurality of RC sizes and the k^{th} plurality of LC sizes may include obtaining a plurality of ideal cache (IC) sizes, setting an (i, j, k)^{th} LC size of the k^{th} plurality of LC sizes to an (i, j)^{th} IC size of the plurality of ideal cache sizes and an (i, j, k)^{th} RC size of the k^{th} plurality of RC sizes to zero, and calculating the k^{th} plurality of LC sizes and the k^{th} plurality of RC sizes. An exemplary plurality of IC sizes may be obtained for the plurality of VMs based on a (k−1)^{th} subset of the primary plurality of I/O requests in a (k−1)^{th} time interval. In an exemplary embodiment, the (i, j, k)^{th} LC size and (i, j, k)^{th} RC size may be set to respective values responsive to a first condition being satisfied. In an exemplary embodiment, the k^{th} plurality of LC sizes and the k^{th} plurality of RC sizes may be calculated by minimizing an average storage latency of the plurality of VMs. An exemplary average storage latency may be minimized responsive to the first condition being violated.

An exemplary plurality of IC sizes may be obtained by obtaining the (i, j)^{th} IC size for the (i, j)^{th} VM. An exemplary (i, j)^{th} IC size may be obtained by calculating a stack distance SD of the (i, j)^{th} VM from the (k−1)^{th} subset and calculating the (i, j)^{th} IC size based on the stack distance SD.

In an exemplary embodiment, minimizing the average storage latency may include minimizing an objective function OF with respect to the (i, j, k)^{th} LC size and the (i, j, k)^{th} RC size. An exemplary objective function OF may be minimized subject to a set of minimization constraints.

In an exemplary embodiment, serving the secondary plurality of I/O requests may include serving an I/O request of the secondary plurality of I/O requests to the (i, j)^{th} VM. An exemplary I/O request may be served responsive to one of a second condition or a third condition being satisfied. An exemplary second condition may include the (i, j, k)^{th} RC size being larger than zero. An exemplary third condition may include the (i, j, k)^{th} RC size being different from an (i, j, k−1)^{th} RC size of a (k−1)^{th} plurality of RC sizes or the (i, j, k)^{th} LC size being different from an (i, j, k−1)^{th} LC size of a (k−1)^{th} plurality of LC sizes.

In an exemplary embodiment, serving the I/O request may include serving a read access request. Serving an exemplary read access request may include directing the read access request to the (i, j)^{th} RC, directing the read access request to the (i, j)^{th} LC, copying a data block of the read access request from the (i, j)^{th} LC to the (i, j)^{th} RC, invalidating the data block in the (i, j)^{th} LC, directing the read access request to a hard disk of the i^{th} PN, and copying the data block from the hard disk to the (i, j)^{th} RC. An exemplary read access request may be directed to the (i, j)^{th} RC responsive to the read access request hitting the (i, j)^{th} RC. An exemplary read access request may be directed to the (i, j)^{th} LC responsive to the read access request missing the (i, j)^{th} RC and the read access request hitting the (i, j)^{th} LC. An exemplary data block of the read access request may be copied from the (i, j)^{th} LC to the (i, j)^{th} RC responsive to the read access request missing the (i, j)^{th} RC and the read access request hitting the (i, j)^{th} LC. An exemplary data block may be invalidated responsive to the read access request missing the (i, j)^{th} RC and the read access request hitting the (i, j)^{th} LC. An exemplary read access request may be directed to the hard disk responsive to the read access request missing the (i, j)^{th} RC and the (i, j)^{th} LC. An exemplary data block may be copied from the hard disk to the (i, j)^{th} RC responsive to the read access request missing the (i, j)^{th} RC and the (i, j)^{th} LC.

Serving an exemplary I/O request may include serving a write access request. An exemplary write access request may be served by directing the write access request to the (i, j)^{th} RC and invalidating a data block of the write access request in the (i, j)^{th} LC responsive to the write access request missing the (i, j)^{th} RC and the write access request hitting the (i, j)^{th} LC.

In an exemplary embodiment, serving the I/O request may include sequentially reading a plurality of local data blocks from the (i, j)^{th} LC, sequentially writing the plurality of local data blocks into the (i, j)^{th} RC, invalidating the plurality of local data blocks in the (i, j)^{th} LC, serving the I/O request by the (i, j)^{th} RC, serving the I/O request by the (i, j)^{th} LC, copying a data block of the I/O request from the (i, j)^{th} LC to the (i, j)^{th} RC, invalidating the data block in the (i, j)^{th} LC, serving the I/O request by a hard disk of the i^{th} PN, and copying the data block from the hard disk to the (i, j)^{th} RC. An exemplary I/O request may be served by the (i, j)^{th} RC responsive to the I/O request hitting the (i, j)^{th} RC. An exemplary I/O request may be served by the (i, j)^{th} LC responsive to the I/O request missing the (i, j)^{th} RC and the I/O request hitting the (i, j)^{th} LC. An exemplary data block may be copied from the (i, j)^{th} LC to the (i, j)^{th} RC responsive to the I/O request missing the (i, j)^{th} RC and the I/O request hitting the (i, j)^{th} LC. An exemplary data block may be invalidated in the (i, j)^{th} LC responsive to the I/O request missing the (i, j)^{th} RC and the I/O request hitting the (i, j)^{th} LC. An exemplary I/O request may be served by a hard disk responsive to the I/O request missing the (i, j)^{th} RC and the (i, j)^{th} LC. An exemplary data block may be copied from the hard disk to the (i, j)^{th} RC responsive to the I/O request missing the (i, j)^{th} RC and the (i, j)^{th} LC.

An exemplary method may further include updating the plurality of LCs and the plurality of RCs. In an exemplary embodiment, updating the plurality of LCs and the plurality of RCs may include one of minimizing a traffic of a network connecting the plurality of PNs and balancing the secondary plurality of I/O requests between the plurality of PNs.

In an exemplary embodiment, minimizing the traffic may include detecting a sequential request of the secondary plurality of I/O requests, serving the sequential request by the (i, j)th LC, detecting a random request of the secondary plurality of I/O requests, and serving the random request by the (i, j)^{th} RC. An exemplary sequential request may be sent to the (i, j)th VM. An exemplary sequential request may be detected responsive to a fourth condition being satisfied. An exemplary fourth condition may include addresses of the sequential request being consecutive and an aggregate size of data blocks associated with the sequential request being larger than a threshold. An exemplary random request may be detected responsive to the fourth condition being violated. An exemplary random request may be sent to the (i, j)^{th} VM.

In an exemplary embodiment, balancing the secondary plurality of I/O requests may include calculating a plurality of queue depths (QDs) for the plurality of PNs, finding a minimum QD of the plurality of QDs and a maximum QD of the plurality of QDs, finding a lowest-loaded VM of the plurality of VMs and a highest-loaded VM of the plurality of VMs, and replacing a data block of a first LC of the plurality of LCs with a data block of a second LC of the plurality of the LCs. An exemplary minimum QD may include a QD of a lowest-loaded PN of the plurality of PNs. An exemplary maximum QD may include a QD of a highest-loaded PN of the plurality of PNs. An exemplary lowest-loaded VM may include a lowest workload between a subset of the plurality of VMs running on the lowest-loaded PN. An exemplary highest-loaded VM may include a highest workload between a subset of the plurality of VMs running on the highest-loaded PN. An exemplary first LC may be assigned to the highest-loaded VM. An exemplary second LC may be assigned to the lowest-loaded VM.

In an exemplary embodiment, allocating the plurality of LCs and the plurality of RCs to the plurality of VMs may include allocating a plurality of solid-state drives to the plurality of VMs.

Other exemplary systems, methods, features and advantages of the implementations will be, or will become, apparent to one of ordinary skill in the art upon examination of the following figures and detailed description. It is intended that all such additional systems, methods, features and advantages be included within this description and this summary, be within the scope of the implementations, and be protected by the claims herein.

### BRIEF DESCRIPTION OF THE DRAWINGS

The drawing figures depict one or more implementations in accord with the present teachings, by way of example only, not by way of limitation. In the figures, like reference numerals refer to the same or similar elements.

FIG. 1A shows a flowchart of a method for cache management in a hyperconverged infrastructure (HCI), consistent with one or more exemplary embodiments of the present disclosure.

FIG. 1B shows a flowchart of a method for allocating a plurality of local caches (LCs) and a plurality of remote caches (RCs), consistent with one or more exemplary embodiments of the present disclosure.

FIG. 1C shows a flowchart of a method for obtaining a plurality of RC sizes and a plurality of LC sizes, consistent with one or more exemplary embodiments of the present disclosure.

FIG. 1D shows a flowchart of a method for obtaining a plurality of ideal cache sizes, consistent with one or more exemplary embodiments of the present disclosure.

FIG. 1E shows a flowchart of a method for serving a read access request, consistent with one or more exemplary embodiments of the present disclosure.

FIG. 1F shows a flowchart of a method for serving a write access request, consistent with one or more exemplary embodiments of the present disclosure.

FIG. 1G shows a flowchart of a method for serving an input/output (I/O) request, consistent with one or more exemplary embodiments of the present disclosure.

FIG. 1H shows a flowchart of a method for minimizing a traffic of a network connecting a plurality of physical nodes (PNs), consistent with one or more exemplary embodiments of the present disclosure.

FIG. 1I shows a flowchart of a method for balancing a plurality of I/O requests between a plurality of PNs, consistent with one or more exemplary embodiments of the present disclosure.

FIG. 2 shows a schematic of an HCI, consistent with one or more exemplary embodiments of the present disclosure.

FIG. 3 shows an LC and an RC of a virtual machine, consistent with one or more exemplary embodiments of the present disclosure.

FIG. 4 shows a schematic of a lowest-loaded PN and a highest-loaded PN, consistent with one or more exemplary embodiments of the present disclosure.

FIG. 5 shows a high-level functional block diagram of a computer system, consistent with one or more exemplary embodiments of the present disclosure.

### DETAILED DESCRIPTION

In the following detailed description, numerous specific details are set forth by way of examples in order to provide a thorough understanding of the relevant teachings. However, it should be apparent that the present teachings may be practiced without such details. In other instances, well known methods, procedures, components, and/or circuitry have been described at a relatively high-level, without detail, in order to avoid unnecessarily obscuring aspects of the present teachings.

The following detailed description is presented to enable a person skilled in the art to make and use the methods and devices disclosed in exemplary embodiments of the present disclosure. For purposes of explanation, specific nomenclature is set forth to provide a thorough understanding of the present disclosure. However, it will be apparent to one skilled in the art that these specific details are not required to practice the disclosed exemplary embodiments. Descriptions of specific exemplary embodiments are provided only as representative examples. Various modifications to the exemplary implementations will be readily apparent to one skilled in the art, and the general principles defined herein may be applied to other implementations and applications without departing from the scope of the present disclosure. The present disclosure is not intended to be limited to the implementations shown, but is to be accorded the widest possible scope consistent with the principles and features disclosed herein.

Herein is disclosed an exemplary method and system for cache management in a hyperconverged infrastructure (HCI). The method may provide improved input/output (I/O) latency and balanced network traffic and I/O cache load in HCI platforms. The method may distribute cache resources within a number of physical nodes (PNs) and may share total cache space throughout the physical nodes. Cache space of PNs may be allocated to virtual machines (VMs) running on PNs to achieve a minimum average latency. Cache allocation may be performed by solving an optimization problem presented by linear programming that determines efficient local and remote cache sizes for each VM. By assigning efficient cache size to active VMs and distributing I/O cache resources within PNs, the method may significantly improve both worst-case and average I/O latency. To reduce network traffic between PNs and to balance I/O load on cache resources, the method may update cache resources allocated to different VMs. In contrast to conventional load balancing schemes that try to cope with large I/O loads by directing I/O requests to a disk subsystem leading to performance loss, the method may respond to all I/O requests from the cache, resulting in lower I/O latency.

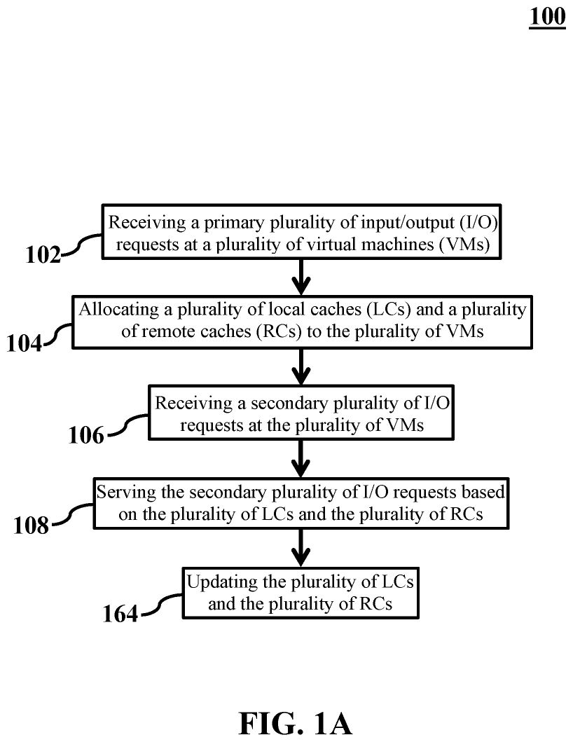

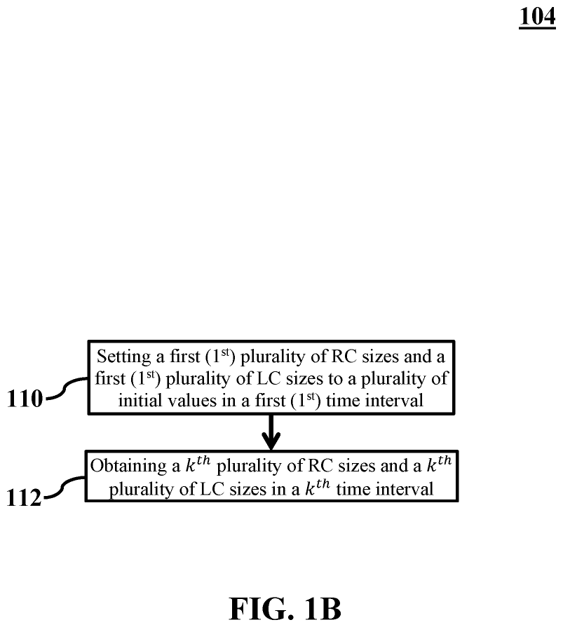

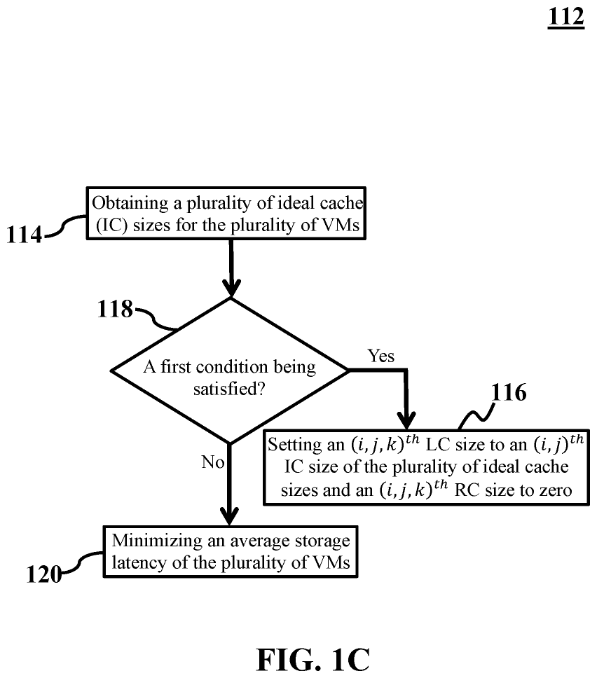

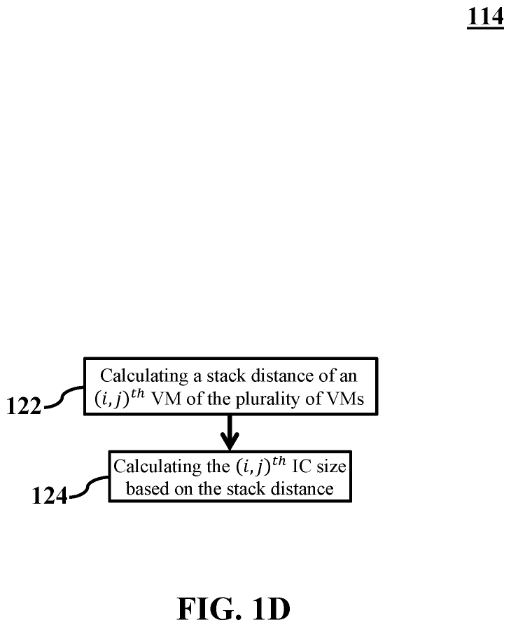

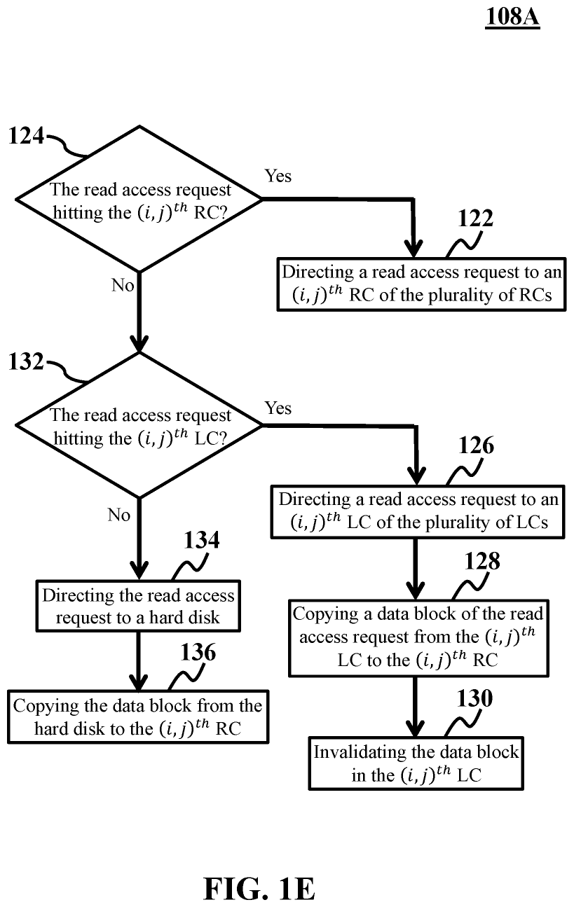

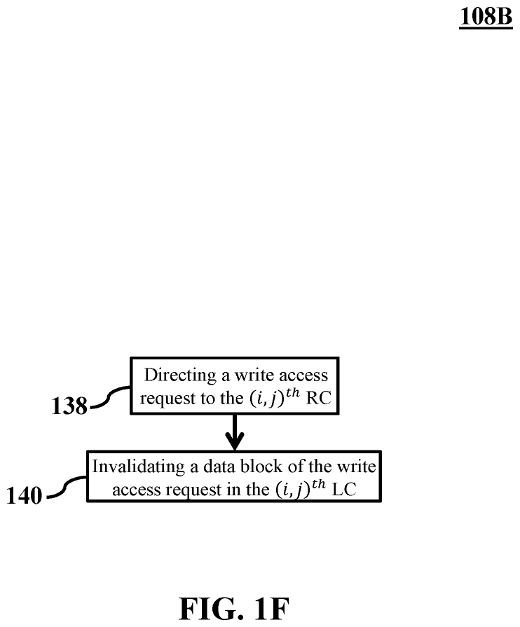

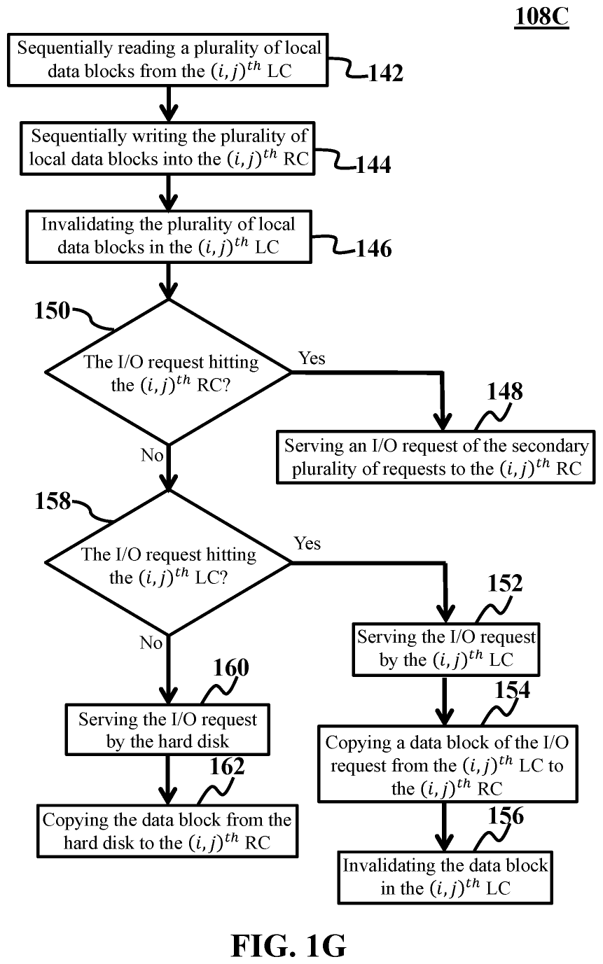

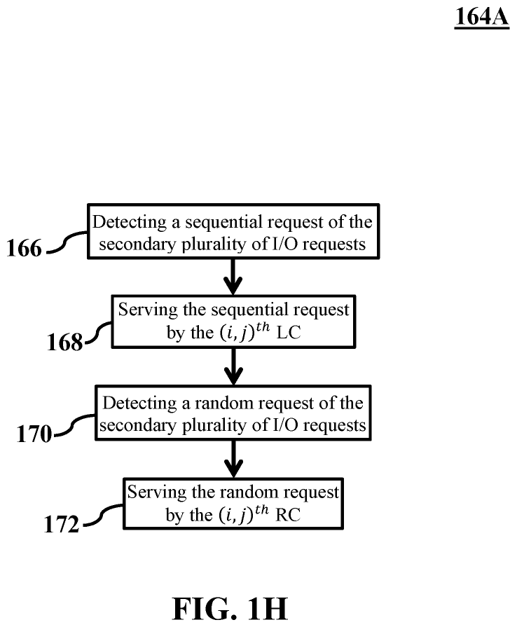

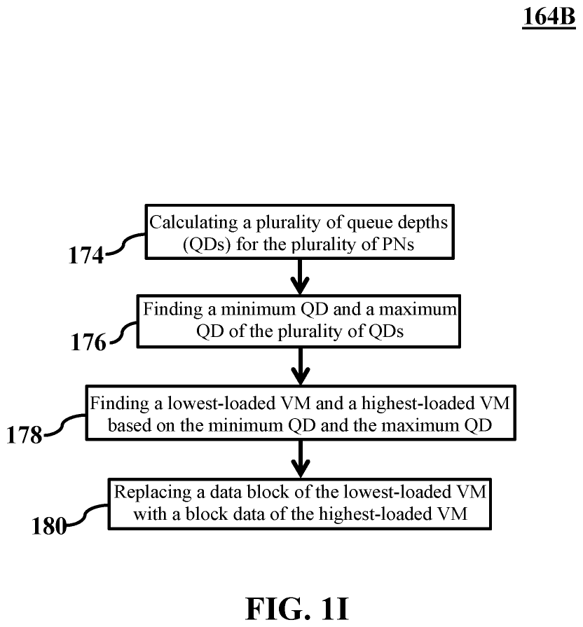

FIG. 1A shows a flowchart of a method for cache management in a hyperconverged infrastructure (HCI), consistent with one or more exemplary embodiments of the present disclosure. In an exemplary embodiment, a method 100 may include receiving a primary plurality of input/output (I/O) requests at a plurality of virtual machines (VMs) (step 102), allocating a plurality of local caches (LCs) and a plurality of remote caches (RCs) to the plurality of VMs (step 104), receiving a secondary plurality of I/O requests at the plurality of VMs (step 106), and serving the secondary plurality of I/O requests (step 108).

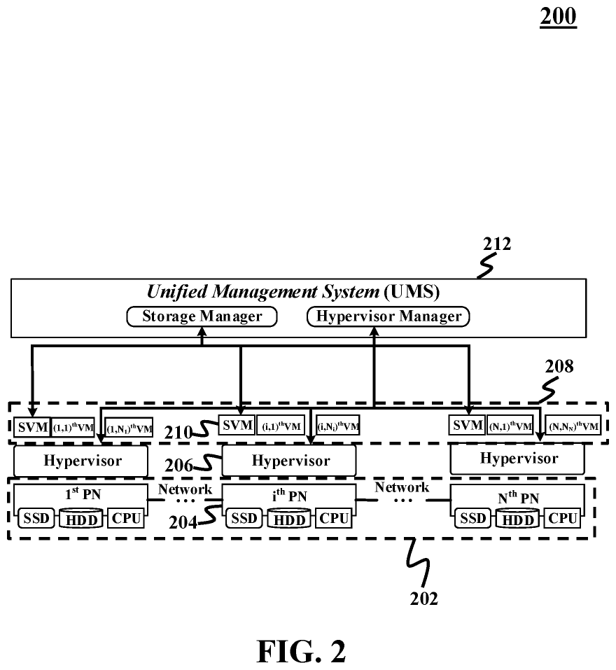

FIG. 2 shows a schematic of an HCI, consistent with one or more exemplary embodiments of the present disclosure. In an exemplary embodiment, an HCI 200 may include a plurality of physical nodes (PNs) 202. Each exemplary PN of plurality of PNs 202 may include a cache memory, a hard disk drive, and a central processing unit (CPU). An exemplary cache memory may include a solid-state drive (SSD). In an exemplary embodiment, storage and processing elements of an i^{th} PN 204 of plurality of PNs 202 may be managed by a hypervisor 206 where 1≤i≤N and N is a number of plurality of PNs 202. In an exemplary embodiment, different hypervisors of HCI 200 may generate a plurality of VMs 208 running on plurality of PNs 202. Each exemplary VM of plurality of VMs 208 may run on a respective corresponding PN of plurality of PNs 202.

Referring to FIGS. 1A and 2, in an exemplary embodiment, hypervisor 206 may host a storage VM (SVM) 210. In an exemplary embodiment, SVM 210 may be responsible for storage sharing across plurality of PNs 202. In an exemplary embodiment, different steps of method 100 may be implemented by a unified management system (UMS) 212. In an exemplary embodiment, UMS 212 may include a storage manager and a hypervisor manager. An exemplary storage manager may dynamically partition total cache space between running VMs and may distribute cache resources through plurality of PNs 202. An exemplary hypervisor manager may manage different hypervisors of plurality of PNs 202 and associated VMs running on each PN.

For further detail with respect to step 102, in an exemplary embodiment, the primary plurality of I/O requests may be received utilizing one or more processors. Each exemplary I/O request may include one of a read access request or a write access request to data blocks of a respective VM od plurality of VMs 208. An exemplary I/O request may be sent to a VM by a user and may be served by one of a cache storage or a hard disk of a PN that hosts the VM. In an exemplary embodiment, allocation of cache storage among plurality of VMs 208 may be determined based on the primary plurality of requests. In other words, in an exemplary embodiment, distribution of the primary plurality of I/O requests to plurality of VMs 208 may be taken into account in a cache allocation scheme to minimize an average storage latency of plurality of VMs 208. As a result, a larger cache storage may be allocated to an exemplary VM with a higher load of I/O requests to avoid high queuing latency and performance drop on the VM.

For further detail with respect to step 104, FIG. 1B shows a flowchart of a method for allocating a plurality of LCs and a plurality of RCs, consistent with one or more exemplary embodiments of the present disclosure. Referring to FIGS. 1B and 2, in an exemplary embodiment, each of plurality of VMs 208 may be allocated a respective local cache (LC) and a respective remote cache (RC). An exemplary LC allocated to a VM may refer to a portion of a cache capacity of a PN that hosts the VM. An exemplary RC allocated to a VM may refer to a portion of a cache capacity of PNs that do not host the VM. In an exemplary embodiment, allocating the plurality of LCs and the plurality of RCs may include allocating an (i, j)^{th} LC of the plurality of LCs and an (i, j)^{th} RC of the plurality of RCs to an (i, j)^{th} VM of plurality of VMs 208 where 1≤j≤Nᵢ and Nᵢ is a number of plurality of VMs 208 running on PN 204.

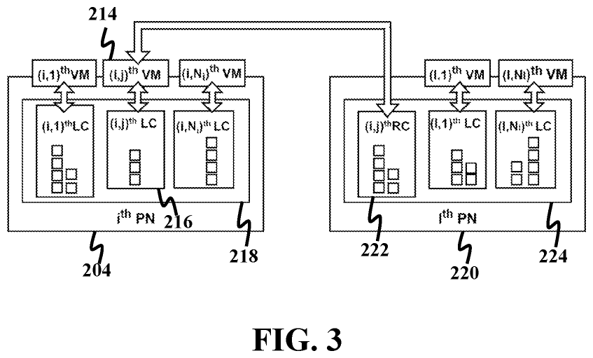

FIG. 3 shows an LC and an RC of a VM, consistent with one or more exemplary embodiments of the present disclosure. Referring to FIGS. 2 and 3, in an exemplary embodiment, an (i, j)^{th} VM 214 of plurality of VMs 208 may run on PN 204. In an exemplary embodiment, an (i, j)^{th} LC 216 of the plurality of LCs assigned to VM 214 may include a portion of a cache space 218 of PN 204. In an exemplary embodiment, plurality of PNs 202 may include an l^{th} PN 220 where 1≤l≤N and l≠i. In an exemplary embodiment, an (i, j)^{th} RC 222 of the plurality of RCs assigned to VM 214 may include a portion of a cache space 224 of PN 220.

Referring to FIGS. 1B and 3, in an exemplary embodiment, allocating LC 216 and the RC 222 may include setting a first (1^{st}) plurality of RC sizes and a first (1^{st}) plurality of LC sizes to a plurality of initial values in a first (1^{st}) time interval (step 110) and obtaining a k^{th} plurality of RC sizes and a k^{th} plurality of LC sizes in a k^{th} time interval where k≥2 (step 112). An exemplary first (1^{st}) plurality of RC sizes may include cache sizes of the plurality of RCs. An exemplary first (1^{st}) plurality of LC sizes may include cache sizes of the plurality of LCs.

In further detail with regard to step 110, in an exemplary embodiment, the plurality of initial values may be obtained by uniformly distributing cache space of a PN among VMs running on the PN.

In further detail with regard to step 112, FIG. 1C shows a flowchart of a method for obtaining a plurality of RC sizes and a plurality of LC sizes, consistent with one or more exemplary embodiments of the present disclosure. Referring to FIGS. 1C and 3, in an exemplary embodiment, obtaining the k^{th} plurality of RC sizes and the k^{th} plurality of LC sizes may include obtaining a plurality of ideal cache (IC) sizes (114), setting an (i, j, k)^{th} LC size of the k^{th} plurality of LC sizes to an (i, j)^{th} IC size of the plurality of ideal cache sizes and an (i, j, k)^{th} RC size of the k^{th} plurality of RC sizes to zero (step 116) responsive to a first condition being satisfied (step 118, Yes), and calculating the k^{th} plurality of LC sizes and the k^{th} plurality of RC sizes (step 120) responsive to the first condition being violated (step 118, No).

For further detail regarding step 114, FIG. 1D shows a flowchart of a method for obtaining a plurality of IC sizes, consistent with one or more exemplary embodiments of the present disclosure. Referring to FIGS. 1D, 2 and 3, in an exemplary embodiment, the plurality of IC sizes may be obtained for plurality of VMs 208 based on a (k−1)^{th} subset of the primary plurality of I/O requests in a (k−1)^{th} time interval. In other words, for each exemplary time interval, the plurality of IC sizes may be obtained based on I/O requests to VMs in a previous time interval. An exemplary plurality of IC sizes may be obtained by obtaining the (i, j)^{th} IC size for VM 214. An exemplary (i, j)^{th} IC size may be obtained for VM 214 such that accessed data blocks of VM 214 in a next time interval are not evicted, given a fixed workload for VM 214 during two consecutive time intervals. A workload of an exemplary VM may be referred to as a number of I/O requests sent to the VM in a certain period of time. In an exemplary embodiment, an exemplary (i, j)^{th} IC size may be obtained by calculating a stack distance SD of VM 214 from the (k−1)^{th} subset (step 122) and calculating the (i, j)^{th} IC size based on the stack distance SD (step 124).

In further detail with respect to step 122, in an exemplary embodiment, SVM 210 may periodically calculate a stack distance of each running VM at hypervisor 206. An exemplary stack distance may include a least recently reused (LRU) stack distance. An exemplary stack distance may include a maximum stack distance of a read after read and a read after write sequence in VM 214. An exemplary stack distance may be calculated from a (k−1)^{th} subset of the primary plurality of I/O requests. In other words, exemplary I/O requests to VM 214 in the (k−1)^{th} time interval may be used to calculate a stack distance for VM 214 in the (k−1)^{th} time interval. Then, an exemplary stack distance may be used to calculate the IC size for VM 214 in the k^{th} time interval.

For further detail with regard to step 124, in an exemplary embodiment, by allocating B>SD cache blocks to VM 214 and given a fixed workload during the (k−1)^{th} time interval and the k^{th} time interval, allocated blocks accessed in the k^{th} time interval may not be evicted. To avoid overprovisioning of cache allocation, in an exemplary embodiment, SD+1 cache blocks may be allocated to VM 214. As a result, in an exemplary embodiment, the (i, j)^{th} IC size may be calculated according to an operation defined by the following:

IC_{i,j}=(SD+1)×BLK, Equation (1)

where IC_{i,j} is the (i, j)^{th} IC size and BLK is a cache block size of HCI 200.

Referring to FIGS. 1C, 2, and 3, in an exemplary embodiment, step 116 may include setting the (i, j, k)^{th} LC size to IC_{i,j} and the (i, j, k)^{th} RC size to zero responsive to the first condition being satisfied. An exemplary (i, j, k)^{th} LC size may include a size of the cache capacity of PN 204 assigned to VM 214 the k^{th} time interval. In other words, an exemplary (i, j, k)^{th} LC size may include a size of LC 216 in the k^{th} time interval. An exemplary (i, j, k)^{th} RC size may be defined according to an operation defined by rc_{i,j}=Σ_{t=1,l≠i}^{N}rc_{i,j}_{ₗ}, where rc_{i,j}_{ₗ} is a size of a cache capacity of PN 220 assigned to VM 214. In other words, in an exemplary embodiment, rc_{i,j}_{ₗ} may include a size of RC 222 in the k^{th} time interval.

In an exemplary embodiment, sufficient cache space may be available at PN 204, that is, an aggregate of ideal cache sizes for all VMs running on PN 204 is less than a cache capacity of PN 204. As a result, in an exemplary embodiment, no RC may need to be allocated to VMs running on PN 204 in the k^{th} time interval, that is, setting the (i, j, k)^{th} RC size to zero.

For further detail regarding step 118, an exemplary first condition may ensure that an aggregate of ideal cache sizes for all VMs running on PN 204 is less than a cache capacity of PN 204. Therefore, an exemplary first condition may be defined according to an operation defined by Σⱼ₌₁^{N}^{ᵢ}IC_{i,j}≤PCᵢ, where PCᵢ is a cache capacity of the PN 204.

In further detail with respect to step 120, in an exemplary embodiment, the k^{th} plurality of LC sizes and the k^{th} plurality of RC sizes may be calculated by minimizing an average storage latency of plurality of VMs 208. An exemplary average storage latency may be minimized responsive to the first condition being violated. In other words, an exemplary cache capacity of PN 204 may not be sufficient to allocate IC size to VM 214 in the k^{th} time interval. As a result, exemplary cache resources may be allocated so that allocated cache spaces do not violate cache capacity of each PN while an average storage latency of I/O requests is minimized. In doing so, an exemplary average latency minimization may be modeled by a linear programming formulation. Minimizing an exemplary average storage latency may include minimizing an objective function OF with respect to the (i, j, k)^{th} LC size and the (i, j, k)^{th} RC size. An exemplary objective function may model an aggregate average storage latency of plurality of VMs 208. In an exemplary embodiment, objective function OF is defined according to an operation defined by the following:

OF=Σᵢ₌₁^{N}Σⱼ₌₁^{N}^{ᵢ}L(VM_{i,j}), Equation (2)

where L(VM_{i,j}) is an average storage latency of VM 214, defined by the following:

$$L ( {VM}_{i , j} ) = \frac{{H}_{i , j} ( {c}_{i , j} )}{{lc}_{i , j} + {rc}_{i , j}} \times [ {lc}_{i , j} \times {L}_{l} + {rc}_{i , j} \times ( {L}_{r} + {L}_{n} ) ] + ( 1 - {H}_{i , j} ( {c}_{i , j} ) ) \times {L}_{h} \qquad Equation ( 3 )$$

where:
lc_{i,j} is the (i, j, k)^{th} LC size,
rc_{i,j} is the (i, j, k)^{th} RC size,
c_{i,j}=lc_{i,j}+rc_{i,j},
H_{i,j}(c_{i,j}) is a hit ratio of VM 214 at c_{i,j},
Lₗ is a latency of each of the plurality of LCs,
Lᵣ is a latency of each of the plurality of RCs,
Lₙ is a latency of a network connecting plurality of PNs 202, and
Lₕ is a latency of a hard disk of each of plurality of PNs 202.

In an exemplary embodiment, objective function OF may be minimized subject to a set of minimization constraints. An exemplary first constraint of the set of minimization constraints may be defined according to the following:

Σᵢ₌₁^{N}Σⱼ₌₁^{N}^{ᵢ}c_{i,j}≤Σᵢ₌₁^{N}PCᵢ. Inequality (1)

An exemplary first constraint may keep an aggregate of cache sizes assigned to plurality of VMs 208 less than an aggregate of cache capacities of plurality of PNs 202. An exemplary second constraint of the set of minimization constraints may be defined according to the following:

rc_{i,j}=Σ_{t=1,t≠i}^{N}rc_{i,j}_{ₜ}, Inequality (2)

An exemplary second constraint may indicate that the (i, j, k)^{th} RC size is sum of cache resources allocated from all PNs other than a hosting node of VM 214, that is, PN 204. An exemplary third constraint of the set of minimization constraints may be defined according to the following:

Σⱼ₌₁^{N}^{ᵢ}lc_{i,j}+Σ_{t=1,t≠i}^{N}Σⱼ₌₁^{N}^{ᵢ}rc_{i,j}_{ₜ}≤PCᵢ, Inequality (3)

An exemplary third constraint may ensure that cache capacity of PN 204, that is, PCᵢ, is greater than or equal to local cache allocated to VMs running on PN 204 and remote cache allocated to VMs running on other nodes. An exemplary fourth constraint of the set of minimization constraints may be defined according to c_{i,j}≤IC_{i,j}. An exemplary fourth constraint, may avoid overprovisioning of cache allocation to VM 214 by keeping allocated cache resources to VM 214 less than the IC size of VM 214.

Referring to FIGS. 1A and 2, in an exemplary embodiment, step 106 may include receiving the secondary plurality of I/O requests. In an exemplary embodiment, receiving the secondary plurality of I/O requests may include receiving an I/O request of the secondary plurality of I/O requests at VM 214. In an exemplary embodiment, the secondary plurality of I/O requests may be received after allocation of the (i, j, k)^{th} LC size and the (i, j, k)^{th} RC size to VM 214.

For further detail with regard to step 108, in an exemplary embodiment, serving the secondary plurality of I/O requests may include serving an I/O request of the secondary plurality of I/O requests to VM 214. An exemplary I/O request may be served responsive to one of a second condition or a third condition being satisfied. An exemplary second condition may include the (i,j, k)^{th} RC size being larger than zero. When RC 222 cache is allocated to VM 214, an exemplary I/O request may be served by directing the I/O request to PN 220 instead of PN 204. In an exemplary embodiment, step 108 may provide detail of directing the I/O request to PN 220. An exemplary third condition may include the (i, j, k)^{th} RC size being different from an (i, j, k−1)^{th} RC size of a (k−1)^{th} plurality of RC sizes or the (i, j, k)^{th} LC size being different from an (i, j, k−1)^{th} LC size of a (k−1)^{th} plurality of LC sizes. When exemplary sizes of allocated LC or RC is different in two consecutive time intervals, some I/O requests may need to be directed from PN 204 to PN 220 or from PN 220 to PN 204. In an exemplary embodiment, step 108 may provide detail of directing the I/O request from PN 204 to PN 220 or from PN 220 to PN 204.

FIG. 1E shows a flowchart of a method for serving a read access request, consistent with one or more exemplary embodiments of the present disclosure. In an exemplary embodiment, step 108A in FIG. 1E may include an implementation of step 108 in FIG. 1A when the I/O request includes a read access request. Referring to FIGS. 1E and 2, serving an exemplary read access request may include directing the read access request to RC 222 (step 122) responsive to the read access request hitting RC 222 (step 124, Yes), directing the read access request to LC 216 (step 126), copying a data block of the read access request from LC 216 to RC 222 (step 128), and invalidating the data block in LC 216 (step 130). In an exemplary embodiment, steps 126-130 may be implemented responsive to the read access request missing RC 222 (step 124, No) and the read access request hitting LC 216 (step 132, Yes). In an exemplary embodiment, method of step 108A may further include directing the read access request to a hard disk of PN 204 (step 134) and copying the data block from the hard disk to RC 222 (step 136). In an exemplary embodiment, steps 134 and 136 may be implemented responsive to the read access request missing RC 222 (step 124, No) and the read access request missing LC 216 (step 132, No).

In further detail regarding step 122, when an exemplary data block of the read access request is present in RC 222, that is, RC 222 is being hit, the read access request is served by RC 222. Serving an exemplary read access request may refer to reading a data block in an address of the read access request.

For further detail with regard to step 124, an exemplary read access request may first be directed to RC 222 to check whether a requested data block is present in RC 222. In case an exemplary data block of the read access is present in RC 222, the read access request may be served according to step 122. Otherwise, an exemplary read access request may be directed to LC 216.

In further detail with respect to step 126, an exemplary read access request may be directed to LC 216 responsive to the read access request missing RC 222. When an exemplary read access request misses RC 222, that is, a block fata of the read access request is not present in RC 222, the read access request may look for the data block in LC 216. When an exemplary read access request finds the data block in LC 216, that is, the read access request hits LC 216, the read access request may be served by LC 216.

For further detail regarding step 128, after serving an exemplary read access request by LC 216, the data block of the read access request may be copied to RC 222 to reduce a response time of future requests, because each read access request may first be directed to RC 222.

In further detail with regard to step 130, an exemplary data block that is copied from LC 216 to RC 222, may be of no use for future requests. Therefore, an exemplary data block may be invalidated in LC 216 to open a cache space for other requests. Invalidating a data block in a cache memory may be referred to as clearing the cache memory of data block.

For further detail with respect to step 132, when an exemplary read access request misses RC 222, LC 216 may be check for whether a data block of the read access request is present in LC 216. In an exemplary embodiment, steps 126-130 may be applicable when the read access request hits LC 216, that is, a data block of the read access request is present in LC 216. Otherwise, an exemplary data block of the read access request may not be present in both RC 222 and LC 216.

For further detail with respect to step 134, when an exemplary read access request misses both RC 222 and LC 216, the read access request may be directed to a hard disk of PN 204. Therefore, an exemplary data block of the read access request may be read from corresponding address in the hard disk.

For further detail with respect to step 136, after reading an exemplary data block of the read access request from the hard disk, the data block may need to be copied from the hard disk to RC 222 to reduce a response time of read access requests in future.

FIG. 1F shows a flowchart of a method for serving a write access request, consistent with one or more exemplary embodiments of the present disclosure. In an exemplary embodiment, step 108B in FIG. 1F may include an implementation of step 108 in FIG. 1A when the I/O request includes a write access request. Referring to FIGS. 1F and 3, an exemplary write access request may be served by directing the write access request to the RC 222 (step 138) and invalidating a data block of the write access request in LC 216 responsive to the write access request missing RC 222 and the write access request hitting LC 216 (step 140).

In further detail regarding step 138, an exemplary write access request may be directed to RC 222. In other words, an exemplary data block of the write access request may be written in a corresponding address of RC 222.

In further detail regarding step 140, an exemplary write access request may be directed to LC 216 responsive to the write access request missing RC 222. Afterwards, and responsive to an exemplary write access request hitting LC 216, the write access request may be served by RC 222 and an address in LC 216 corresponding to the write access request may be invalidated.

Referring to FIGS. 1E, 1F, 2, and 3, in an exemplary embodiment, steps 108A and 108B may gradually move LC resources of VM 214 to RC resources. In other words, an exemplary data block may be moved from LC 216 to RC 222 responsive to a read access request to the data block. Besides, exemplary data blocks of write access requests may be written in RC 222 only responsive to arrival of corresponding write access requests. As a result, in an exemplary embodiment, steps 108A and 108B may reduce a traffic on a network connecting plurality of PNs 202 because data blocks may not be transferred between LC 216 and RC 222 at once.

FIG. 1G shows a flowchart of a method for serving an I/O request, consistent with one or more exemplary embodiments of the present disclosure. In an exemplary embodiment, step 108C in FIG. 1G may include an implementation of step 108 in FIG. 1A. Referring to FIGS. 1G and 3, in an exemplary embodiment, serving the I/O request may include sequentially reading a plurality of local data blocks from LC 216 (step 142), sequentially writing the plurality of local data blocks into RC 222 (step 144), invalidating the plurality of local data blocks in LC 216 (step 146), serving the I/O request by RC 222 (step 148) responsive to the I/O request hitting RC 222 (step 150, Yes), serving the I/O request by LC 216 (step 152), copying a data block of the I/O request from LC 216 to RC 222 (step 154), and invalidating the data block in LC 216 (step 156). In an exemplary embodiment, steps 152-156 may be implemented responsive to the I/O request missing RC 222 (step 150, No) and the I/O request hitting LC 216 (step 158, Yes). In an exemplary embodiment, responsive to the I/O request missing RC 222 (step 150, No) and the I/O request missing LC 216 (step 158, No), a method of step 108C may further include serving the I/O request by a hard disk of the PN 204 (step 160) and copying the data block from the hard disk to RC 222 (step 162).

For further detail with respect to step 142, in an exemplary embodiment, the plurality of local data blocks may need to be transferred from LC 216 to RC 222. In an exemplary embodiment, the plurality of data blocks may be chosen according a size of RC 216. In other words, in an exemplary embodiment, the plurality of data blocks may be transferred from LC 216 to RC 222 so that an allocated space for RC 222 may be occupied by data blocks in LC 216. In doing so, in an exemplary embodiment, the plurality of data blocks may be sequentially read from LC 216.

In further detail with regard to step 144, in an exemplary embodiment, the plurality of data blocks may be sequentially written in RC 222 to complete transferring of the plurality of data blocks from LC 216 to RC 222.

For further detail regarding step 146, in an exemplary embodiment, after writing the plurality of data blocks in RC 222, the plurality of data blocks in LC 216 may be of no use and may unnecessarily occupy LC 216. Therefore, in an exemplary embodiment, the plurality of data blocks in LC 216 may be invalidated to open cache space for future requests sent to VM 214.

In further detail with respect to steps 148-162, in an exemplary embodiment, serving the I/O request may be similar to serving the read access request in steps 122-136 of FIG. 1E, as described in the following. An exemplary I/O request may first be directed to RC 222. Then, an exemplary I/O request may be served by RC 222 responsive to RC 222 hitting the I/O request. Otherwise, that is, when an exemplary I/O request misses RC 222, the I/O request may be served by LC 216 responsive to the I/O request hitting LC 216. Then, an exemplary data block of the I/O request may be copied from LC 216 to RC 222 and the data bock in LC 216 may be invalidated. In case an exemplary I/O request misses both RC 222 and LC 216, the I/O request may be directed to and served by the hard disk of PN 204. Next, an exemplary data block of the I/O request may be copied from the hard disk to RC 222.

Referring again to FIGS. 1A, 2, and 3, in an exemplary embodiment, method 100 may further include updating the plurality of LCs and the plurality of RCs (step 164). In an exemplary embodiment, updating the plurality of LCs and the plurality of RCs may include one of minimizing a traffic of a network connecting plurality of PNs 202 and balancing the secondary plurality of I/O requests between plurality of PNs 202. In an exemplary embodiment, workloads of plurality of VMs 208 may radically change within an exemplary time interval. As a result, in an exemplary embodiment, a performance of plurality of VMs 208 may decrease because the plurality of LCs and the plurality of RCs are allocated to plurality of VMs 208 with assumption of fixed workload of plurality of VMs 208 within two consecutive time intervals. Therefore, in an exemplary embodiment, the plurality of LCs and the plurality of RCs may be updated within each time interval to adapt a cache resource allocation with varying workloads.

For further detail regarding step 164, FIG. 1H shows a flowchart of a method for minimizing a traffic of a network connecting a plurality of PNs, consistent with one or more exemplary embodiments of the present disclosure. Referring to FIGS. 1A, 1H, 2, and 3, in an exemplary embodiment, minimizing a traffic of a network connecting plurality of PNs 202 in step 164A may include an implementation of updating the plurality of LCs and the plurality of RCs in step 164. In an exemplary embodiment, minimizing the traffic may include detecting a sequential request of the secondary plurality of I/O requests (step 166), serving the sequential request by LC 216 (step 168), detecting a random request of the secondary plurality of I/O requests (step 170), and serving the random request by RC 222 (step 172).

In further detail with regard to step 166, an exemplary sequential request may be sent to VM 214. An exemplary sequential request may be detected responsive to a fourth condition being satisfied. An exemplary fourth condition may include addresses of the sequential request being consecutive and an aggregate size of data blocks of the sequential request being larger than a threshold. An exemplary threshold may be set to 64 KB. An exemplary sequential request may need to read/write a large amount of data from/into a cache memory. As a result, in an exemplary embodiment, directing data blocks of the sequential request to RC 222 may cause a bandwidth bottleneck in the network connecting plurality of PNs 202. Therefore, an exemplary sequential request may be served by LC 216.

For further detail with respect to step 168, an exemplary sequential request may be served by LC 216. In other words, exemplary data blocks of the sequential request may be read from LC 216 when the sequential request includes a read access request. In contrast, exemplary data blocks of the sequential request may be written into LC 216 when the sequential request includes a write access request.

In further detail regrading step 170, an exemplary random request may be detected responsive to the fourth condition being violated. An exemplary random request may be sent to VM 214. An exemplary request may be considered a random request when the request is not detected as a sequential request.

In further detail regrading step 172, an exemplary data block of the random request may not be so large that cause a bandwidth bottleneck on the network. As a result, an exemplary random request may be directed to RC 222 to reserve cache space in LC 216 for future possible sequential requests.

FIG. 1I shows a flowchart of a method for balancing a plurality of I/O requests between a plurality of PNs, consistent with one or more exemplary embodiments of the present disclosure. In an exemplary embodiment, balancing the secondary plurality of I/O requests between plurality of PNs 202 in step 164B of FIG. 11 may include an implementation of updating the plurality of LCs and the plurality of RCs in step 164 of FIG. 1A. Referring to FIGS. 1I, 2, and 3, in an exemplary embodiment, balancing the secondary plurality of I/O requests may include calculating a plurality of queue depths (QDs) for plurality of PNs 202 (step 174), finding a minimum QD of the plurality of QDs and a maximum QD of the plurality of QDs (step 176), finding a lowest-loaded VM of the plurality of VMs and a highest-loaded VM of plurality of VMs 208 (step 178), and replacing a data block of a first LC of the plurality of LCs with a data block of a second LC of the plurality of the LCs (step 180). In an exemplary embodiment, non-uniform distribution of workloads among plurality of VMs 208 may overload some PNs while other PNs are underutilized. Therefore, in an exemplary embodiment, balancing the second plurality of I/O requests may balance utilized cache space among different PNs.

For further detail with respect to step 174, in an exemplary embodiment, each of the plurality of QDs may be calculated for a respective corresponding PN of plurality of PNs 202. A QD of an exemplary PN may be referred to as a number of waiting I/O requests in a cache queue of the PN. An exemplary QD may be a representative for a load on cache resources of each PN. According to definition, an exemplary large QD may lead to larger storage latency. Exemplary QD of plurality of PNs 202 may be calculated by enumerating a number of pending I/O requests at each of plurality of PNs 202.

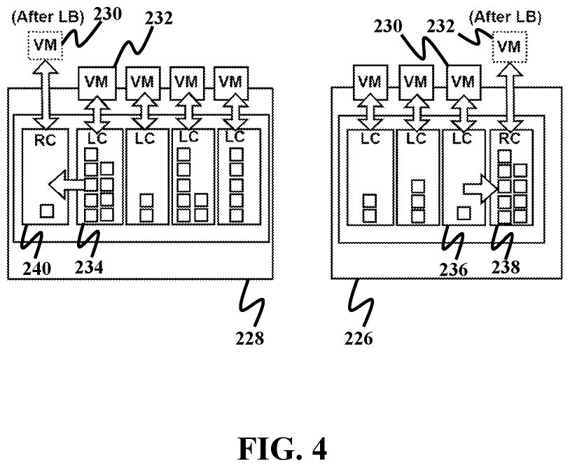

For further detail with respect to step 176, FIG. 4 shows a schematic of a lowest-loaded PN and a highest-loaded PN, consistent with one or more exemplary embodiments of the present disclosure. Referring to FIGS. 1I, 2, and 4, an exemplary minimum QD may be found by finding a minimum of the plurality of QDs. An exemplary minimum QD may include a QD of a lowest-loaded PN 226 of plurality of PNs 202. An exemplary maximum QD may be found by finding a maximum of the plurality of QDs. An exemplary maximum QD may include a QD of a highest-loaded PN 228 of plurality of PNs 202.

For further detail with respect to step 178, in an exemplary embodiment, a lowest-loaded VM 230 may include a lowest workload between a subset of plurality of VMs 208 running on lowest-loaded PN 226. In an exemplary embodiment, lowest-loaded VM 230 may be found by finding workloads of different VMs running on lowest-loaded PN 226 and finding a VM with lowest workload. In an exemplary embodiment, a highest-loaded VM 232 may include a highest workload between a subset of plurality of VMs 208 running on highest-loaded PN 228. In an exemplary embodiment, highest-loaded VM 232 may be found by finding workloads of different VMs running on highest-loaded PN 228 and finding a VM with highest workload.

For further detail with respect to step 180, in an exemplary embodiment, a first LC 234 may be assigned to highest-loaded VM 232. In an exemplary embodiment, a second LC 236 may be assigned to lowest-loaded VM 230. In an exemplary embodiment, replacing first LC 234 with second LC 236 may decrease a workload of highest-loaded PN 228. After load balancing (LB), in an exemplary embodiment, an RC 238 may include data blocks of first LC 234. Similarly, in an exemplary embodiment, an RC 240 may include data blocks of second LC 236 after LB.

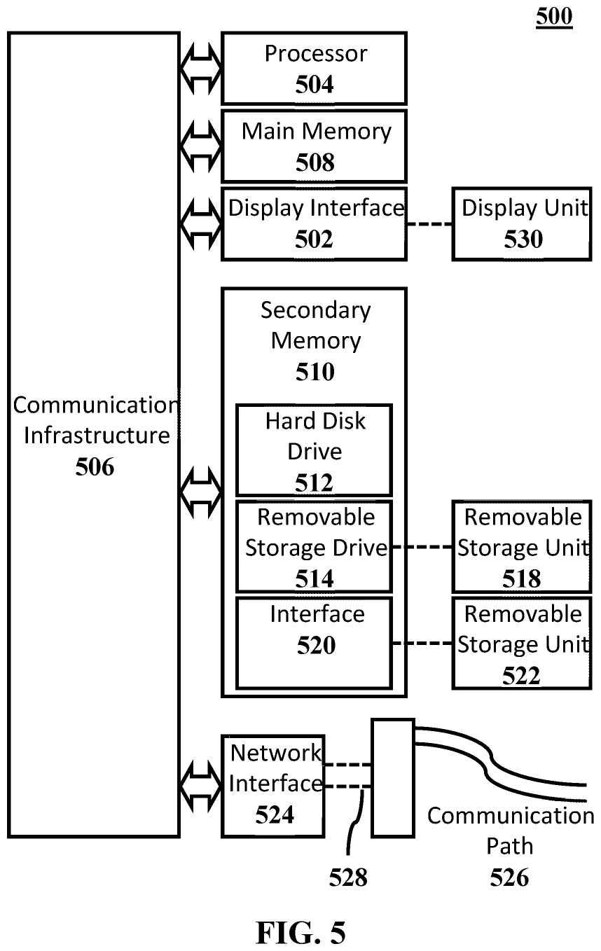

FIG. 5 shows an example computer system 500 in which an embodiment of the present invention, or portions thereof, may be implemented as computer-readable code, consistent with exemplary embodiments of the present disclosure. For example, method 100 may be implemented in computer system 500 using hardware, software, firmware, tangible computer readable media having instructions stored thereon, or a combination thereof and may be implemented in one or more computer systems or other processing systems. Hardware, software, or any combination of such may embody any of the modules and components in FIGS. 1A-4.

If programmable logic is used, such logic may execute on a commercially available processing platform or a special purpose device. One ordinary skill in the art may appreciate that an embodiment of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device.

For instance, a computing device having at least one processor device and a memory may be used to implement the above-described embodiments. A processor device may be a single processor, a plurality of processors, or combinations thereof. Processor devices may have one or more processor “cores.”

An embodiment of the invention is described in terms of this example computer system 500. After reading this description, it will become apparent to a person skilled in the relevant art how to implement the invention using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 504 may be a special purpose or a general-purpose processor device. As will be appreciated by persons skilled in the relevant art, processor device 504 may also be a single processor in a multi-core/multiprocessor system, such system operating alone, or in a cluster of computing devices operating in a cluster or server farm. Processor device 504 may be connected to a communication infrastructure 506, for example, a bus, message queue, network, or multi-core message-passing scheme.

In an exemplary embodiment, computer system 500 may include a display interface 502, for example a video connector, to transfer data to a display unit 530, for example, a monitor. Computer system 500 may also include a main memory 508, for example, random access memory (RAM), and may also include a secondary memory 510. Secondary memory 510 may include, for example, a hard disk drive 512, and a removable storage drive 514. Removable storage drive 514 may include a floppy disk drive, a magnetic tape drive, an optical disk drive, a flash memory, or the like. Removable storage drive 514 may read from and/or write to a removable storage unit 518 in a well-known manner. Removable storage unit 518 may include a floppy disk, a magnetic tape, an optical disk, etc., which may be read by and written to by removable storage drive 514. As will be appreciated by persons skilled in the relevant art, removable storage unit 518 may include a computer usable storage medium having stored therein computer software and/or data.

In alternative implementations, secondary memory 510 may include other similar means for allowing computer programs or other instructions to be loaded into computer system 500. Such means may include, for example, a removable storage unit 522 and an interface 520. Examples of such means may include a program cartridge and cartridge interface (such as that found in video game devices), a removable memory chip (such as an EPROM, or PROM) and associated socket, and other removable storage units 522 and interfaces 520 which allow software and data to be transferred from removable storage unit 522 to computer system 500.

Computer system 500 may also include a communications interface 524. Communications interface 524 allows software and data to be transferred between computer system 500 and external devices. Communications interface 524 may include a modem, a network interface (such as an Ethernet card), a communications port, a PCMCIA slot and card, or the like. Software and data transferred via communications interface 524 may be in the form of signals, which may be electronic, electromagnetic, optical, or other signals capable of being received by communications interface 524. These signals may be provided to communications interface 524 via a communications path 526. Communications path 526 carries signals and may be implemented using wire or cable, fiber optics, a phone line, a cellular phone link, an RF link or other communications channels.

In this document, the terms “computer program medium” and “computer usable medium” are used to generally refer to media such as removable storage unit 518, removable storage unit 522, and a hard disk installed in hard disk drive 512. Computer program medium and computer usable medium may also refer to memories, such as main memory 508 and secondary memory 510, which may be memory semiconductors (e.g. DRAMs, etc.).

Computer programs (also called computer control logic) are stored in main memory 508 and/or secondary memory 510. Computer programs may also be received via communications interface 524. Such computer programs, when executed, enable computer system 500 to implement different embodiments of the present disclosure as discussed herein. In particular, the computer programs, when executed, enable processor device 504 to implement the processes of the present disclosure, such as the operations in method 100 illustrated by flowcharts 100-1064B of FIGS. 1A-1I discussed above. Accordingly, such computer programs represent controllers of computer system 500. Where an exemplary embodiment of method 100 is implemented using software, the software may be stored in a computer program product and loaded into computer system 500 using removable storage drive 514, interface 520, and hard disk drive 512, or communications interface 524.

Embodiments of the present disclosure also may be directed to computer program products including software stored on any computer useable medium. Such software, when executed in one or more data processing device, causes a data processing device to operate as described herein. An embodiment of the present disclosure may employ any computer useable or readable medium. Examples of computer useable mediums include, but are not limited to, primary storage devices (e.g., any type of random access memory), secondary storage devices (e.g., hard drives, floppy disks, CD ROMS, ZIP disks, tapes, magnetic storage devices, and optical storage devices, MEMS, nanotechnological storage device, etc.).

The embodiments have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

While the foregoing has described what may be considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various implementations. This is for purposes of streamlining the disclosure, and is not to be interpreted as reflecting an intention that the claimed implementations require more features than are expressly recited in each claim. Rather, as the following claims reflect, inventive subject matter lies in less than all features of a single disclosed implementation. Thus, the following claims are hereby incorporated into the Detailed Description, with each claim standing on its own as a separately claimed subject matter.

While various implementations have been described, the description is intended to be exemplary, rather than limiting and it will be apparent to those of ordinary skill in the art that many more implementations and implementations are possible that are within the scope of the implementations. Although many possible combinations of features are shown in the accompanying figures and discussed in this detailed description, many other combinations of the disclosed features are possible. Any feature of any implementation may be used in combination with or substituted for any other feature or element in any other implementation unless specifically restricted. Therefore, it will be understood that any of the features shown and/or discussed in the present disclosure may be implemented together in any suitable combination. Accordingly, the implementations are not to be restricted except in light of the attached claims and their equivalents. Also, various modifications and changes may be made within the scope of the attached claims.

What is claimed is:

1. A method for cache management in a hyperconverged infrastructure (HCI) comprising a plurality of physical nodes (PNs), the method comprising:
receiving, utilizing one or more processors, a primary plurality of input/output (I/O) requests at a plurality of virtual machines (VMs), each of the plurality of VMs running on a respective corresponding PN of the plurality of PNs;
allocating, utilizing the one or more processors, a plurality of local caches (LCs) and a plurality of remote caches (RCs) to the plurality of VMs by allocating an (i, j)^{th} LC of the plurality of LCs and an (i, j)^{th} RC of the plurality of RCs to an (i, j)^{th} VM of the plurality of VMs where 1≤i≤N, 1≤j≤Nᵢ, N is a number of the plurality of PNs, Nᵢ is a number of the plurality of VMs running on an i^{th} PN of the plurality of PNs, allocating the (i, j)^{th} LC and the (i, j)^{th} RC comprising:
setting a first (1^{st}) plurality of RC sizes and a first (1^{st}) plurality of LC sizes to a plurality of initial values in a first (1^{st}) time interval, the first (1^{st}) plurality of RC sizes comprising cache sizes of the plurality of RCs, and the first (1^{st}) plurality of LC sizes comprising cache sizes of the plurality of LCs; and
obtaining a k^{th} plurality of RC sizes and a k^{th} plurality of LC sizes in a k^{th} time interval where k≥2 by:
obtaining a plurality of ideal cache (IC) sizes for the plurality of VMs by obtaining an (i, j)^{th} IC size of the plurality of IC sizes for the (i, j)^{th} VM, comprising:
calculating a stack distance SD of the VM_{i,j} from a (k−1)^{th} subset of the primary plurality of I/O requests in a (k−1)^{th} time interval; and
calculating the (i,j)^{th} IC size according to an operation defined by IC_{i,j}=(SD+1)×BLK where IC_{i,j} is the (i, j)^{th} IC size and BLK is a cache block size of the HCI;
setting an (i, j, k)^{th} LC size of the k^{th} plurality of LC sizes to the (i, j)^{th} IC size and an (i, j, k)^{th} RC size of the k^{th} plurality of RC sizes to zero responsive to a first condition being satisfied, the first condition defined according to the following:
Σⱼ₌₁^{N}^{ᵢ}IC_{i,j}≤PCᵢ
where PCᵢ is a cache capacity of the i^{th} PN,
wherein:
the (i, j, k)^{th} LC size is a size of the cache capacity of the i^{th} PN assigned to the (i, j)^{th} VM; and
the (i, j, k)^{th} RC size is defined according to the following:
rc_{i,j}=Σ_{t=1,l≠i}^{N}rc_{i,j}_{ₗ}
where rc_{i,j}_{ₗ} is a size of a cache capacity of an l^{th} PN of the plurality of PNs where 1≤l≤N and ;≠i, the cache capacity of the l^{th} PN assigned to the (i, j)^{th} VM; and
calculating the k^{th} plurality of LC sizes and the k^{th} plurality of RC sizes by minimizing an average storage latency of the plurality of VMs responsive to the first condition being violated, minimizing the average storage latency comprises minimizing an objective function OF with respect to the (i, j, k)^{th} LC size and the (i, j, k)^{th} RC size subject to a set of minimization constraints, wherein:
the objective function OF is defined according to an operation defined by the following:
$$OF = {\sum }_{i = 1}^{N} {\sum }_{j = 1}^{{N}_{i}} L ( {VM}_{i , j} ) , where :$$
$$L ( {VM}_{i , j} ) = \frac{{H}_{i , j} ( {c}_{i , j} )}{{lc}_{i , j} + {rc}_{i , j}} \times [ {lc}_{i , j} \times {L}_{l} + {rc}_{i , j} \times ( {L}_{r} + {L}_{n} ) ] + ( 1 - {H}_{i , j} ( {c}_{i , j} ) ) \times {L}_{h}$$
where:
lc_{i,j} is the (i, j, k)^{th} LC size,
rc_{i,j} is the (i, j, k)^{th} RC size,
c_{i,j}=lc_{i,j}+rc_{i,j},
H_{i,j}(c_{i,j}) is a hit ratio of the (i, j)^{th} VM at c_{i,j},
Lₗ is a latency of each of the plurality of LCs,
Lᵣ is a latency of each of the plurality of RCs,
Lₙ is a latency of a network connecting the plurality of PNs, and
Lₕ is a latency of a hard disk of each of the plurality of PNs;
wherein:
the (i, j)^{th} VM runs on the i^{th} PN;
the (i, j)^{th} LC comprises a portion of a cache space of the i^{th} PN; and
the (i, j)^{th} RC comprises a portion of a cache space of the l^{th} PN;
receiving, utilizing the one or more processors, a secondary plurality of I/O requests at the plurality of VMs; and
serving, utilizing the one or more processors, the secondary plurality of I/O requests based on the plurality of LCs and the plurality of RCs, by serving an I/O request of the secondary plurality of I/O requests to the (i, j)^{th} VM responsive to one of a second condition or a third condition being satisfied, serving the I/O request comprising one of:
serving a read access request by:
directing the read access request to the (i, j)^{th} RC responsive to the read access request hitting the (i, j)^{th} RC;
responsive to the read access request missing the (i, j)^{th} RC and the read access request hitting the (i, j)^{th} LC:
directing the read access request to the (i, j)^{th} LC;
copying a data block of the read access request from the (i, j)^{th} LC to the (i, j)^{th} RC; and
invalidating the data block in the (i, j)^{th} LC; and
responsive to the read access request missing the (i, j)^{th} RC and the (i, j)^{th} LC:
directing the read access request to a hard disk of the i^{th} PN; and
copying the data block from the hard disk to the (i, j)^{th} RC; and
serving a write access request by:
directing the write access request to the (i, j)^{th} RC; and
invalidating a data block of the write access request in the (i, j)^{th} LC responsive to the write access request missing the (i, j)^{th} RC and the write access request hitting the (i, j)^{th} LC,
wherein:
the second condition comprises the (i, j, k)^{th} RC size being larger than zero; and
the third condition comprises the (i, j, k)^{th} RC size being different from an (i, j, k−1)^{th} RC size of a (k−1)^{th} plurality of RC sizes or the (i, j, k)^{th} LC size being different from an (i, j, k−1)^{th} LC size of a (k−1)^{th} plurality of LC sizes.

2. A method for cache management in a hyperconverged infrastructure (HCI) comprising a plurality of physical nodes (PNs), the method comprising:
receiving, utilizing one or more processors, a primary plurality of input/output (I/O) requests at a plurality of virtual machines (VMs), each of the plurality of VMs running on a respective corresponding PN of the plurality of PNs;
allocating, utilizing the one or more processors, a plurality of local caches (LCs) and a plurality of remote caches (RCs) to the plurality of VMs based on the primary plurality of I/O requests;
receiving, utilizing the one or more processors, a secondary plurality of I/O requests at the plurality of VMs; and
serving, utilizing the one or more processors, the secondary plurality of I/O requests based on the plurality of LCs and the plurality of RCs.

3. The method of claim 2, wherein allocating the plurality of LCs and the plurality of RCs comprises allocating an (i, j)^{th} LC of the plurality of LCs and an (i, j)^{th} RC of the plurality of RCs to an (i, j)^{th} VM of the plurality of VMs where 1≤i≤N, 1≤j≤Nᵢ, N is a number of the plurality of PNs, Nᵢ is a number of the plurality of VMs running on an i^{th} PN of the plurality of PNs, wherein:
the (i, j)^{th} VM runs on the i^{th} PN;
the (i, j)^{th} LC comprises a portion of a cache space of the i^{th} PN; and
the (i, j)^{th} RC comprises a portion of a cache space of an l^{th} PN of the plurality of PNs where 1≤l≤N and l≠i.

4. The method of claim 3, wherein allocating the (i, j)^{th} LC and the (i, j)^{th} RC comprises:
setting a first (1^{st}) plurality of RC sizes and a first (1^{st}) plurality of LC sizes to a plurality of initial values in a first (1^{st}) time interval, the first (1^{st}) plurality of RC sizes comprising cache sizes of the plurality of RCs, and the first (1^{st}) plurality of LC sizes comprising cache sizes of the plurality of LCs; and
obtaining a k^{th} plurality of RC sizes and a k^{th} plurality of LC sizes in a k^{th} time interval where k≥2 by:
obtaining a plurality of ideal cache (IC) sizes for the plurality of VMs based on a (k−1)^{th} subset of the primary plurality of I/O requests in a (k−1)^{th} time interval;
setting an (i, j, k)^{th} LC size of the k^{th} plurality of LC sizes to an (i, j)^{th} IC size of the plurality of IC sizes and an (i, j, k)^{th} RC size of the k^{th} plurality of RC sizes to zero responsive to a first condition being satisfied, the first condition defined according to the following:
Σⱼ₌₁^{N}^{ᵢ}IC_{i,j}≤PCᵢ
where IC_{i,j} is the (i, j)^{th} IC size and PCᵢ is a cache capacity of the i^{th} PN,
wherein:
the (i, j, k)^{th} LC size is a size of the cache capacity of the i^{th} PN assigned to the (i, j)^{th} VM; and
the (i ,j, k)^{th} RC size is defined according to the following:
rc_{i,j}=Σ_{t=1,l≠i}^{N}rc_{i,j}
where rc_{i,j}_{ₗ} is a size of a cache capacity of the l^{th} PN assigned to the (i, j)^{th} VM; and
calculating the k^{th} plurality of LC sizes and the k^{th} plurality of RC sizes by minimizing an average storage latency of the plurality of VMs responsive to the first condition being violated.

5. The method of claim 4, wherein obtaining the plurality of IC sizes comprises obtaining the (i, j)^{th} IC size by:
calculating a stack distance SD of the (i, j)^{th} VM from the (k−1)^{th} subset; and
calculating the (i, j)^{th} IC size according to an operation defined by IC_{i,j}=(SD+1)×BLK where BLK is a cache block size of the HCI.

6. The method of claim 4, wherein minimizing the average storage latency comprises minimizing an objective function OF with respect to the (i, j, k)^{th} LC size and the (i, j, k)^{th} RC size subject to a set of minimization constraints, wherein:
the objective function OF is defined according to an operation defined by the following:
$$OF = {\sum }_{i = 1}^{N} {\sum }_{j = 1}^{{N}_{i}} L ( {VM}_{i , j} ) , where :$$
$$L ( {VM}_{i , j} ) = \frac{{H}_{i , j} ( {c}_{i , j} )}{{lc}_{i , j} + {rc}_{i , j}} \times [ {lc}_{i , j} \times {L}_{l} + {rc}_{i , j} \times ( {L}_{r} + {L}_{n} ) ] + ( 1 - {H}_{i , j} ( {c}_{i , j} ) ) \times {L}_{h}$$
where:
lc_{i,j} is the (i, j, k)^{th} LC size,
rc_{i,j} is the (i, j, k)^{th} RC size,
c_{i,j}=lc_{i,j}+rc_{i,j},
H_{i,j}(c_{i,j}) is a hit ratio of the (i, j)^{th} VM at c_{i,j},
Lₗ is a latency of each of the plurality of LCs,
Lᵣ is a latency of each of the plurality of RCs,
Lₙ is a latency of a network connecting the plurality of PNs, and
Lₕ is a latency of a hard disk of each of the plurality of PNs; and
the set of minimization constraints comprises:
a first constraint defined according to the following:
$${\sum }_{i = 1}^{N} {\sum }_{j = 1}^{{N}_{i}} {c}_{i , j} \leq {\sum }_{i = 1}^{N} {PC}_{i} ;$$
a second constraint defined according to the following:
rc_{i,j}=Σ_{t=1,t≠i}^{N}rc_{i,j}_{ₜ};
a third constraint defined according to the following:
$${\sum }_{j = 1}^{{N}_{i}} {lc}_{i , j} + {\sum }_{t = 1 , t \neq i}^{N} {\sum }_{j = 1}^{{N}_{i}} {rc}_{i , {j}_{t}} \leq {PC}_{i} ;$$
and
a fourth constraint defined according to the following:
c_{i,j}≤IC_{i,j}.

7. The method of claim 4, wherein serving the secondary plurality of I/O requests comprises serving an I/O request of the secondary plurality of I/O requests to the (i,j)^{th} VM responsive to one of a second condition or a third condition being satisfied, wherein:
the second condition comprises the (i, j, k)^{th} RC size being larger than zero; and
the third condition comprises the (i, j, k)^{th} RC size being different from an (i, j, k−1)^{th} RC size of a (k−1)^{th} plurality of RC sizes or the (i, j, k)^{th} LC size being different from an (i, j, k−1)^{th} LC size of a (k−1)^{th} plurality of LC sizes.

8. The method of claim 7, wherein serving the I/O request comprises serving a read access request by:
directing the read access request to the (i, j)^{th} RC responsive to the read access request hitting the (i, j)^{th} RC;
responsive to the read access request missing the (i, j)^{th} RC and the read access request hitting the (i, j)^{th} LC:
directing the read access request to the (i, j)^{th} LC;
copying a data block of the read access request from the (i, j)^{th} LC to the (i, j)^{th} RC; and
invalidating the data block in the (i, j)^{th} LC; and
responsive to the read access request missing the (i, j)^{th} RC and the (i, j)^{th} LC:
directing the read access request to a hard disk of the i^{th} PN; and
copying the data block from the hard disk to the (i, j)^{th} RC.

9. The method of claim 7, wherein serving the I/O request comprises serving a write access request by:
directing the write access request to the (i, j)^{th} RC; and
invalidating a data block of the write access request in the (i, j)^{th} LC responsive to the write access request missing the (i, j)^{th} RC and the write access request hitting the (i, j)^{th} LC.

10. The method of claim 7, wherein serving the I/O request comprises:
sequentially reading a plurality of local data blocks from the (i, j)^{th} LC;
sequentially writing the plurality of local data blocks into the (i, j)^{th} RC;
invalidating the plurality of local data blocks in the (i, j)^{th} LC;
serving the I/O request by the (i, j)^{th} RC responsive to the I/O request hitting the (i, j)^{th} RC;
responsive to the I/O request missing the (i, j)^{th} RC and the I/O request hitting the (i, j)^{th} LC:
serving the I/O request by the (i, j)^{th} LC;
copying a data block of the I/O request from the (i, j)^{th} LC to the (i, j)^{th} RC; and
invalidating the data block in the (i, j)^{th} LC; and
responsive to the I/O request missing the (i, j)^{th} RC and the (i, j)^{th} LC:
serving the I/O request by a hard disk of the i^{th} PN; and
copying the data block from the hard disk to the (i, j)^{th} RC.

11. The method of claim 3, further comprising updating the plurality of LCs and the plurality of RCs by one of:
minimizing a traffic of a network connecting the plurality of PNs; and
balancing the secondary plurality of I/O requests between the plurality of PNs.

12. The method of claim 11, wherein minimizing the traffic comprises:
detecting a sequential request of the secondary plurality of I/O requests responsive to a fourth condition being satisfied, the sequential request being sent to the (i, j)^{th} VM, the fourth condition comprising:
addresses of the sequential request being consecutive; and
an aggregate size of data blocks associated with the sequential request being larger than a threshold;
serving the sequential request by the (i, j)^{th} LC;
detecting a random request of the secondary plurality of I/O requests responsive to the fourth condition being violated, the random request being sent to the (i, j)^{th} VM; and
serving the random request by the (i, j)^{th} RC.

13. The method of claim 11, wherein balancing the secondary plurality of I/O requests comprises:
calculating a plurality of queue depths (QDs) for the plurality of PNs;
finding a minimum QD of the plurality of QDs and a maximum QD of the plurality of QDs, the minimum QD comprising a QD of a lowest-loaded PN of the plurality of PNs and the maximum QD comprising a QD of a highest-loaded PN of the plurality of PNs;
finding a lowest-loaded VM of the plurality of VMs and a highest-loaded VM of the plurality of VMs, wherein:
the lowest-loaded VM comprises a lowest workload between a subset of the plurality of VMs running on the lowest-loaded PN; and
the highest-loaded VM comprises a highest workload between a subset of the plurality of VMs running on the highest-loaded PN; and
replacing a data block of a first LC of the plurality of LCs with a data block of a second LC of the plurality of the LCs, the first LC assigned to the highest-loaded VM and the second LC assigned to the lowest-loaded VM.

14. The method of claim 2, wherein allocating the plurality of LCs and the plurality of RCs to the plurality of VMs comprises allocating a plurality of solid-state drives to the plurality of VMs.

15. A system for cache management in a hyperconverged infrastructure (HCI) comprising a plurality of physical nodes (PNs), the system comprising:
a memory having processor-readable instructions stored therein; and
a processor configured to access the memory and execute the processor-readable instructions, which, when executed by the processor configures the processor to perform a method, the method comprising:
receiving a primary plurality of input/output (I/O) requests at a plurality of virtual machines (VMs), each of the plurality of VMs running on a respective corresponding PN of the plurality of PNs;
allocating a plurality of local caches (LCs) and a plurality of remote caches (RCs) to the plurality of VMs based on the primary plurality of I/O requests by allocating an (i, j)^{th} LC of the plurality of LCs and an (i, j)^{th} RC of the plurality of RCs to an (i, j)^{th} VM of the plurality of VMs where 1≤i≤N, 1≤j≤Nᵢ, N is a number of the plurality of PNs, Nᵢ is a number of the plurality of VMs running on an i^{th} PN of the plurality of PNs, wherein:
the (i, j)^{th} VM runs on the i^{th} PN;
the (i, j)^{th} LC comprises a portion of a cache space of the i^{th} PN; and
the (i, j)^{th} RC comprises a portion of a cache space of an l^{th} PN of the plurality of PNs where 1≤l≤N and l≠i;
receiving a secondary plurality of I/O requests at the plurality of VMs; and
serving the secondary plurality of I/O requests based on the plurality of LCs and the plurality of RCs.

16. The system of claim 15, wherein allocating the (i, j)^{th} LC and the (i, j)^{th} RC comprises:
setting a first (1^{st}) plurality of RC sizes and a first (1^{st}) plurality of LC sizes to a plurality of initial values in a first (1^{st}) time interval, the first (1^{st}) plurality of RC sizes comprising cache sizes of the plurality of RCs, and the first (1^{st}) plurality of LC sizes comprising cache sizes of the plurality of LCs; and
obtaining a k^{th} plurality of RC sizes and a k^{th} plurality of LC sizes in a k^{th} time interval where k≥2 by:
obtaining a plurality of ideal cache (IC) sizes for the plurality of VMs by obtaining an (i, j)^{th} IC size of the plurality of IC sizes, comprising:
calculating a stack distance SD of the (i, j)^{th} VM from a (k−1)^{th} subset of the primary plurality of I/O requests in a (k−1)^{th} time interval; and
calculating the (i, j)^{th} IC size according to an operation defined by IC_{i,j}=(SD+1)×BLK where IC_{i,j} is the (i, j)^{th} IC size and BLK is a cache block size of the HCI;
setting an (i, j, k)^{th} LC size of the k^{th} plurality of LC sizes to the (i, j)^{th} IC size and an (i, j, k)^{th} RC size of the k^{th} plurality of RC sizes to zero responsive to a first condition being satisfied, the first condition defined according to the following:
Σⱼ₌₁^{N}^{ᵢ}IC_{i,j}≤PCᵢ
where PCᵢ is a cache capacity of the i^{th} PN,
wherein:
the (i, j, k)^{th} LC size is a size of the cache capacity of the i^{th} PN assigned to the (i, j)^{th} VM; and
the (i, j, k)^{th} RC size is defined according to the following:
rc_{i,j}=Σ_{t=1,l≠i}^{N}rc_{i,j}_{ₗ}
where rc_{i,j}_{ᵢ} is a size of a cache capacity of the l^{th} PN
assigned to the (i, j)^{th} VM; and
calculating the k^{th} plurality of LC sizes and the k^{th} plurality of RC sizes by minimizing an average storage latency of the plurality of VMs responsive to the first condition being violated, minimizing the average storage latency comprising minimizing an objective function OF with respect to the (i, j, k)^{th} LC size and the (i, j, k)^{th} RC size subject to a set of minimization constraints, wherein:
the objective function OF is defined according to an operation defined by the following:
$$OF = {\sum }_{i = 1}^{N} {\sum }_{j = 1}^{{N}_{i}} L ( {VM}_{i , j} ) , where :$$
$$L ( {VM}_{i , j} ) = \frac{{H}_{i , j} ( {c}_{i , j} )}{{lc}_{i , j} + {rc}_{i , j}} \times [ {lc}_{i , j} \times {L}_{l} + {rc}_{i , j} \times ( {L}_{r} + {L}_{n} ) ] + ( 1 - {H}_{i , j} ( {c}_{i , j} ) ) \times {L}_{h}$$
where:
lc_{i,j} is the (i, j, k)^{th} LC size,
rc_{i,j} is the (i, j, k)^{th} RC size,
c_{i,j}=lc_{i,j}+rc_{i,j},
H_{i,j}(c_{i,j}) is a hit ratio of the (i, j)^{th} VM at c_{i,j},
Lₗ is a latency of each of the plurality of LCs,
Lᵣ is a latency of each of the plurality of RCs,
Lₙ is a latency of a network connecting the plurality of PNs, and
Lₕ is a latency of a hard disk of each of the plurality of PNs; and
the set of minimization constraints comprises:
a first constraint defined according to the following:
$${\sum }_{i = 1}^{N} {\sum }_{j = 1}^{{N}_{i}} {c}_{i , j} \leq {\sum }_{i = 1}^{N} {PC}_{i} ;$$
a second constraint defined according to the following:
rc_{i,j}=Σ_{t=1,t≠i}^{N}rc_{i,j}_{ₜ};
a third constraint defined according to the following:
$${\sum }_{j = 1}^{{N}_{i}} {lc}_{i , j} + {\sum }_{t = 1 , t \neq i}^{N} {\sum }_{j = 1}^{{N}_{i}} {rc}_{i , {j}_{t}} \leq {PC}_{i} ;$$
and
a fourth constraint defined according to the following:
c_{i,j}≤IC_{i,j}.

17. The system of claim 16, wherein serving the secondary plurality of I/O requests comprises serving an I/O request of the secondary plurality of I/O requests to the (i, j)^{th} VM responsive to one of a second condition or a third condition being satisfied, wherein:
the second condition comprises the (i, j, k)^{th} RC size being larger than zero; and
the third condition comprises the (i, j, k)^{th} RC size being different from an (i, j, k−1)^{th} RC size of a (k−1)^{th} plurality of RC sizes or the (i, j, k)^{th} LC size being different from an (i, j, k−1)^{th} LC size of a (k−1)^{th} plurality of LC sizes.

18. The system of claim 17, wherein serving the I/O request comprises one of:
serving a read access request by:
directing the read access request to the (i, j)^{th} RC responsive to the read access request hitting the (i, j)^{th} RC;
responsive to the read access request missing the (i, j)^{th} RC and the read access request hitting the (i, j)^{th} LC:
directing the read access request to the (i, j)^{th} LC;
copying a data block of the read access request from the (i, j)^{th} LC to the (i, j)^{th} RC; and
invalidating the data block in the (i, j)^{th} LC; and
responsive to the read access request missing the (i, j)^{th} RC and the (i, j)^{th} LC:
directing the read access request to a hard disk of the i^{th} PN; and
copying the data block from the hard disk to the (i, j)^{th} RC;
serving a write access request by:
directing the write access request to the (i, j)^{th} RC; and
invalidating a data block of the write access request in the (i, j)^{th} LC responsive to the write access request missing the (i, j)^{th} RC and the write access request hitting the (i, j)^{th} LC; and

19. The system of claim 17, wherein serving the I/O request comprises:
sequentially reading a plurality of local data blocks from the (i, j)^{th} LC;
sequentially writing the plurality of local data blocks into the (i, j)^{th} RC;
invalidating the plurality of local data blocks in the (i, j)^{th} LC;
serving the I/O request by the (i, j)^{th} RC responsive to the I/O request hitting the (i, j)^{th} RC;
responsive to the I/O request missing the (i,j)^{th} RC and the I/O request hitting the (i, j)^{th} LC:
serving the I/O request by the (i, j)^{th} LC;
copying a data block of the I/O request from the (i, j)^{th} LC to the (i, j)^{th} RC; and
invalidating the data block in the (i, j)^{th} LC; and
responsive to the I/O request missing the (i, j)^{th} RC and the (i, j)^{th} LC:
serving the I/O request by a hard disk of the i^{th} PN; and
copying the data block from the hard disk to the (i, j)^{th} RC.

20. The system of claim 15, wherein the method further comprises updating the plurality of LCs and the plurality of RCs by one of:
minimizing a traffic of a network connecting the plurality of PNs by:
detecting a sequential request of the secondary plurality of I/O requests responsive to a fourth condition being satisfied, the sequential request being sent to the (i, j)^{th} VM, the fourth condition comprising:
addresses of the sequential request being consecutive; and
an aggregate size of data blocks associated with the sequential request being larger than a threshold;
serving the sequential request by the (i, j)^{th} LC;
detecting a random request of the secondary plurality of I/O requests responsive to the fourth condition being violated, the random request being sent to the (i, j)^{th} VM; and
serving the random request by the (i, j)^{th} RC; and
balancing the secondary plurality of I/O requests between the plurality of PNs by:
calculating a plurality of queue depths (QDs) for the plurality of PNs;
finding a minimum QD of the plurality of QDs and a maximum QD of the plurality of QDs, the minimum QD comprising a QD of a lowest-loaded PN of the plurality of PNs and the maximum QD comprising a QD of a highest-loaded PN of the plurality of PNs;
finding a lowest-loaded VM of the plurality of VMs and a highest-loaded VM of the plurality of VMs, wherein:
the lowest-loaded VM comprises a lowest workload between a subset of the plurality of VMs running on the lowest-loaded PN; and
the highest-loaded VM comprises a highest workload between a subset of the plurality of VMs running on the highest-loaded PN; and
replacing a data block of a first LC of the plurality of LCs with a data block of a second LC of the plurality of the LCs, the first LC assigned to the highest-loaded VM and the second LC assigned to the lowest-loaded VM.
